(19) United States
(12) Patent Application Publication
(10) Pub. No.: US 2006/0075310 A1
(43) Pub. Date: Apr. 6, 2006

(54) Microcomputer and trace control method capable of tracing desired task

(75) Inventor: Koutarou Tagawa, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 11/023,646

(22) Filed: Dec. 29, 2004

(30) Foreign Application Priority Data
Sep. 21, 2004 (JP) 2004-273941

(51) Int. Cl. G06F 11/00

(52) U.S. Cl. 714/45

(57) ABSTRACT

A microcomputer includes a bus, a CPU coupled to the bus, a trace data generating circuit coupled to the bus to output trace data of a process executed by the CPU at an output node, a memory coupled to the output node of the trace data generating circuit to store the trace data, a first register coupled to the bus to store a task number indicative of a task being executed by the CPU, and a control unit coupled to the first register to control on/off of outputting of the trace data from the trace data generating circuit in response to the task number.

### CROSS-REFERENCE TO RELATED APPLICATIONS

The present application is based upon and claims the benefit of priority from the prior Japanese Patent Application No. 2004-273941 filed on Sep. 21, 2004, with the Japanese Patent Office, the entire contents of which are incorporated herein by reference.

### BACKGROUND OF THE INVENTION

1. Field of the Invention

The present invention generally relates to microcomputers and trace control methods, and particularly relates to a microcomputer and trace control method that are capable of controlling the on/off state of trace operations.

2. Description of the Related Art

When a system using a microcomputer is to be developed, an evaluation-purpose chip (evaluation chip) is produced. Unlike microcomputer chips for mass production, the evaluation-purpose chip is equipped with the interface and RAM for use in emulation. Debugging is then performed with respect to the evaluation-purpose chip, which operates in the same manner as the microcomputer chips for mass production. To be specific, an ICE (in-circuit emulator) is connected to the ICE interface of the evaluation-purpose chip (evaluation chip), and the operation of the microcomputer is controlled through the ICE by use of a personal computer. The personal computer executes programs to perform various debug operations.

FIG. 1 is a block diagram showing the configuration of a related-art debugging environment. The debugging system of FIG. 1 includes a microcomputer 1 serving as an evaluation-purpose chip, an ICE 16 for debugging the evaluation-purpose chip, and a personal computer 17 which controls the ICE 16 based on debugger software. A general-purpose communication cable 18 such as a USB couples between the personal computer 17 and the ICE 16. A tool bus 13, which is an interface for emulation, couples between the ICE 16 and the microcomputer 1.

The microcomputer 1 includes a CPU 2, a bus interface 3, a debug support unit (hereinafter referred to as DSU) 4 coupled to the ICE 16 through the tool bus 13, a trace circuit 5, a trace memory 6, a command bus 7, and a data bus 8. The bus interface 3 is an interface for unifying the command bus 7 and the data bus 8 into an external user bus 9. The external user bus 9 is coupled to a RAM that stores user programs executed by the microcomputer 1, for example. The trace circuit 5 monitors the command bus 7 and the data bus 8 to generate trace data. The trace memory 6 stores the trace data generated by the trace circuit 5. A data-write bus 10 is used by the trace circuit 5 to write data to the trace memory 6. A data-read bus 11 is used to read the trace data stored in the trace memory 6 for provision to the ICE through the DSU 4. A bus 12 is used to pass the trace data retrieved by the trace circuit 5 to the DSU 4. A bus 14 is a dedicated bus for use by the DSU 4 to control the CPU 2 in response to instructions from the ICE 16. A control signal line 15 is used to send trace conditions and the like from the built-in registers of the DSU 4 to the trace circuit 5.

A user who debugs the microcomputer system uses debugger software commands to set trace conditions and the like in the built-in registers of the DSU 4 via the ICE 16. At this time, the CPU 2 is in such a state as to wait for commands supplied from the ICE 16 and to execute an emulator program in response to the supplied commands. Namely, the CPU 2 operates based on the commands supplied from the ICE 16 through the DSU 4 and the bus 14. Such an operation mode is called an emulator mode.

Upon finishing the setting of trace conditions and the like, the user instructs the debugger to execute a program to be debugged (hereinafter referred to as a user program). In response, a command requesting the execution of the user program is sent to the CPU 2 through the DSU 4. The CPU 2 makes a state transition from the emulator mode to the mode for the execution of a user program (hereinafter referred to as a user mode), thereby executing the user program from an address specified by the user.

The trace circuit 5 performs tracing in the trace mode specified by the DSU 4 via the control signal line 15. The trace circuit 5 continues tracing the execution of the user program until the CPU 2 shifts to the emulator mode again in response to a break point set in the program or the like. The trace data generated by the trace circuit 5 are immediately stored in the trace memory 6. The trace data is a list of data such as executed instructions and write/read addresses arranged in a time sequence.

The trace data in the trace memory 6 are transferred to the ICE 16 via the trace circuit 5 and the DSU 4 at proper timing. To be specific, the DSU 4 checks the state of the usage of the tool bus 13 and instructs the trace circuit 5 to read, thereby transferring the trace data from the trace memory 6 to the ICE 16 while the CPU 2 is executing the user program in the user mode. Depending on the register setting of the DSU 4, the trace data may be transferred from the trace memory 6 to the personal computer 17 via the trace circuit 5, the DSU 4, and the ICE 16 according to an instruction from the debugger program after the CPU 2 shifts to the emulator mode.

When debugging is performed with respect to a task that operates on the multitask OS, the trace data of the task of interest may be buried in the trace data of other tasks. This results in a significant drop in debug efficiency. In consideration of this, the system disclosed in Non-Patent Document 1 allows a debugger to select the trace data of the task of interest by referring to program addresses or the like among all the trace data transferred to the personal computer 17. The selected trace data alone is then displayed on the screen of the personal computer 17.

The system disclosed in Non-Patent Document 2 provides the trace circuit 5 with a control register for controlling the on/off state of a trace operation. By utilizing this register, the user adds routines for the on/off control of a trace operation at the beginning and end of the routine for which trace data is desired, thereby providing for only the trace data of a desired range to be collected.

[Non-Patent Document 1]

“Mitsubishi Microcomputer M32R Family,” Mitsubishi Electric Corp., March, 2002

[Non-Patent Document 2]

“SH7709S Group Hardware Manual”, pp. 7-11, [online], Sep. 9, 2003, Renesas Technology, [Searched on Aug. 24, 2004], on the Internet <URL:http://www.renesas.com/avs/resource/japan/jpn/pdf/mpumcu/rjj09b0074_sh7709s.pdf>

When two or more tasks are present on the multitask OS, the trace data generated by the system as shown in FIG. 1 includes the trace data of all the tasks inclusive of the OS. Accordingly, the trace data of the task of interest for debugging ends up being buried in the trace data of the other tasks, resulting in a significant drop in debug efficiency. Further, this ends up requiring an extra space for storing excess trace data.

In the microcomputers, the essential circuit portion for providing the function of the microcomputer such as a CPU and cache memories occupies a large circuit area, so that a trace memory for use in storing trace data cannot be provided with large capacity. Accordingly, an attempt to store all the trace data in the trace memory provided inside the chip results in the memory space being insufficient for the purpose of analyzing the operation of a routine to be debugged.

In the system in which the trace data is consecutively output to the ICE provided outside the chip, it becomes increasingly difficult to secure a sufficient bus-band width for outputting the trace data as the internal operation speed of the microcomputer increases. Even if the built-in trace memory is used as a buffer for absorbing a speed difference between the interior and exterior of the chip, the buffer may be likely to overflow, resulting in the loss of trace data.

It is possible to generate and display trace information excluding an excess portion if the personal computer selects and displays trace data as in the system disclosed in Non-Patent Document 1. However, the trace data stored in the trace memory still includes unnecessary data, and, thus, such a configuration does not provide a solution to the problem of insufficient capacity of the trace memory. Further, since an extra time is necessary to select trace data prior to the display of trace results on the screen of the personal computer, the user friendliness of the debugger is compromised.

The technology disclosed in Non-Patent Document 2 can control the on/off state of a trace operation. Simplistic on/off control provided by the control register, however, is bound to have difficulty collecting trace data only for a particular task in the multitask OS environment.

Accordingly, there is a need for a microcomputer and trace control method which can store only the trace data of the task to be debugged in a trace memory.

### SUMMARY OF THE INVENTION

It is a general object of the present invention to provide a microcomputer and a trace control method that substantially obviate one or more problems caused by the limitations and disadvantages of the related art.

Features and advantages of the present invention will be presented in the description which follows, and in part will become apparent from the description and the accompanying drawings, or may be learned by practice of the invention according to the teachings provided in the description. Objects as well as other features and advantages of the present invention will be realized and attained by a microcomputer and trace control method particularly pointed out in the specification in such full, clear, concise, and exact terms as to enable a person having ordinary skill in the art to practice the invention.

To achieve these and other advantages in accordance with the purpose of the invention, the invention provides a microcomputer which includes a bus, a CPU coupled to the bus, a trace data generating circuit coupled to the bus to output trace data of a process executed by the CPU at an output node, a memory coupled to the output node of the trace data generating circuit to store the trace data, a first register coupled to the bus to store a task number indicative of a task being executed by the CPU, and a control unit coupled to the first register to control on/off of outputting of the trace data from the trace data generating circuit in response to the task number.

According to another aspect of the invention, a method of controlling tracing in a microcomputer includes the steps of letting a CPU execute a user program, letting the CPU store in a first register a task number of a currently executed task during the execution of the user program, and controlling on/off of recording of trace data with respect to a process executed by the CPU in response to the task number stored in the first register.

According to at least one embodiment of the invention, during the development of a system using a microcomputer, the debugger specifies information about a task to be traced at the time of debugging, thereby making it possible to collect only the trace information about a desired task. This improves the efficiency of user debug operation. Further, the resultant efficient use of a limited trace memory can avoids the shortage of memory space at the time of trace data recording, and can record the trace data for a longer period despite the use of the trace memory having the same size.

### BRIEF DESCRIPTION OF THE DRAWINGS

Other objects and further features of the present invention will be apparent from the following detailed description when read in conjunction with the accompanying drawings, in which;

FIG. 1 is a block diagram showing the configuration of a related-art debugging environment;

FIG. 2 is a block diagram showing an example of the configuration of a debugging system according to the present invention;

FIG. 3 is a block diagram showing a basic configuration of a DSU of a microcomputer according to the present invention;

FIG. 4 is a flowchart showing the procedure performed when the debugging system of FIG. 2 debugs the microcomputer provided with the DSU shown in FIG. 3;

FIG. 5 is a sequence chart showing the sequence of operations performed by a user, a debugger, and an evaluation chip;

FIG. 6 is a block diagram showing an example of the embodiment of the DSU;

FIG. 7 is a timing chart showing the rewrite timing of a register unit;

FIG. 8 is a circuit diagram showing an example of the construction of the register unit and a trace-on/off controlling unit of FIG. 4;

FIG. 9 is a circuit diagram showing another example of the construction of the register unit and the trace-on/off controlling unit; and

FIG. 10 is a circuit diagram showing the construction in which task number comparison is provided with a masking function.

### DESCRIPTION OF THE PREFERRED EMBODIMENTS

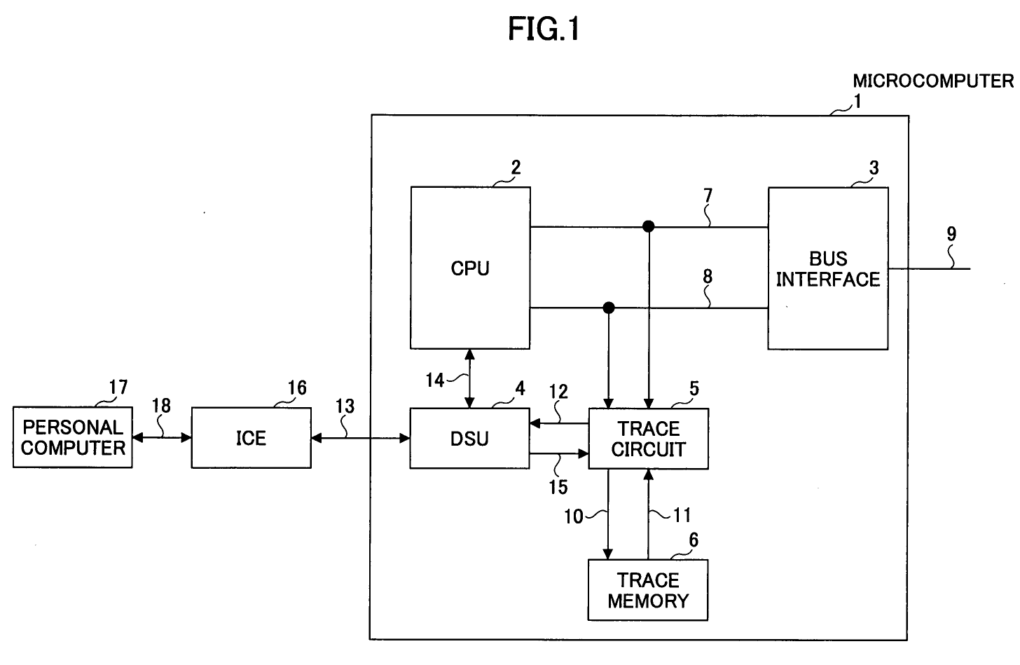

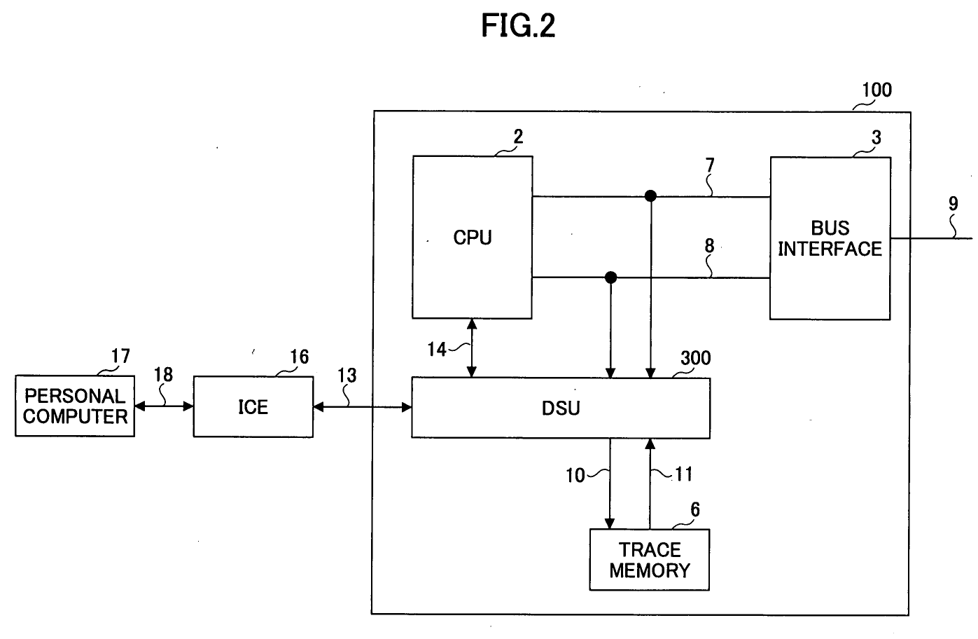

FIG. 2 is a block diagram showing an example of the configuration of a debugging system according to the present invention. In FIG. 2, the same elements as those of FIG. 1 are referred to by the same numerals.

The debugging system of FIG. 2 includes a microcomputer 100 serving as an evaluation-purpose chip of the present invention, the ICE 16 for debugging the evaluation-purpose chip, and the personal computer 17 which controls the ICE 16 based on debugger software. The general-purpose communication cable 18 such as a USB couples between the personal computer 17 and the ICE 16. The tool bus 13, which is an interface for emulation, couples between the ICE 16 and the microcomputer 100.

The microcomputer 100 includes the CPU 2, the bus interface 3, a debug support unit (hereinafter referred to as a DSU) 300 coupled to the ICE 16 through the tool bus 13, the trace memory 6, the command bus 7, and the data bus 8. The bus interface 3 is an interface for unifying the command bus 7 and the data bus 8 into the external user bus 9. The external user bus 9 is coupled to a RAM that stores user programs executed by the microcomputer 100, for example. In the microcomputer 100 shown in FIG. 2, a trace circuit is provided as a built-in component inside the DSU 300.

The data-write bus 10 is used by the trace circuit to write data to the trace memory 6. The data-read bus 11 is used to read the trace data stored in the trace memory 6 for provision to the ICE through the DSU 4.

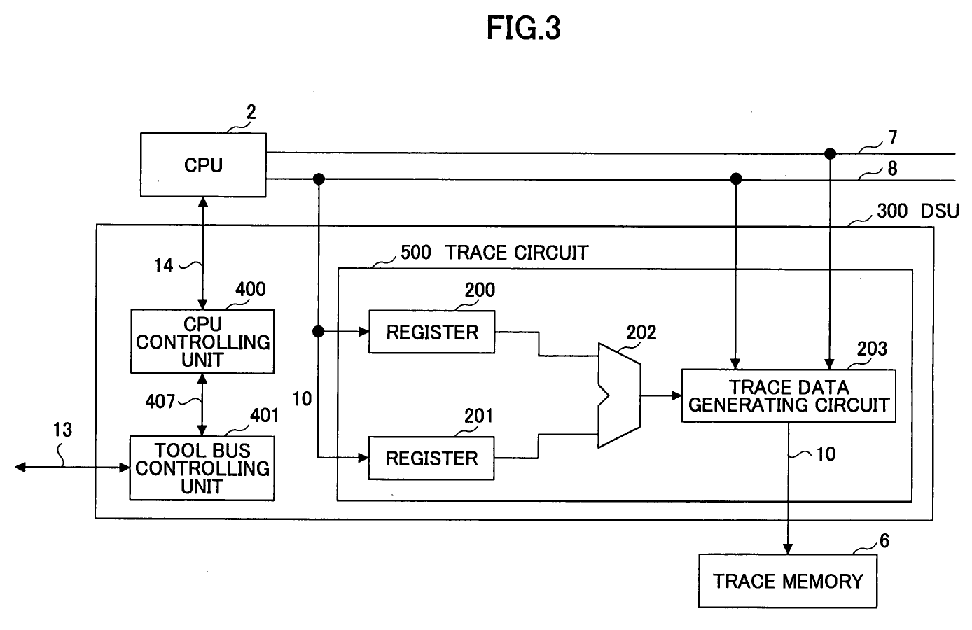

FIG. 3 is a block diagram showing a basic configuration of the DSU 300 of the microcomputer 100 according to the present invention. The DSU 300 of FIG. 3 includes a CPU controlling unit 400, a tool bus controlling unit 401, and a trace circuit 500. The trace circuit 500 includes a register 200, a register 201, a comparator 202, and a trace data generating circuit 203.

The register 200 stores the task number of a task being executed. The register 201 specifies the task number indicative of the task to be traced. The comparator 202 compares the stored value of the register 200 with the stored value of the register 201. The trace data generating circuit 203 stores in the trace memory 6 the trace data generated from data on the command bus 7 and data bus 8 in response to a matching indication provided by the comparator 202 as a result of comparison.

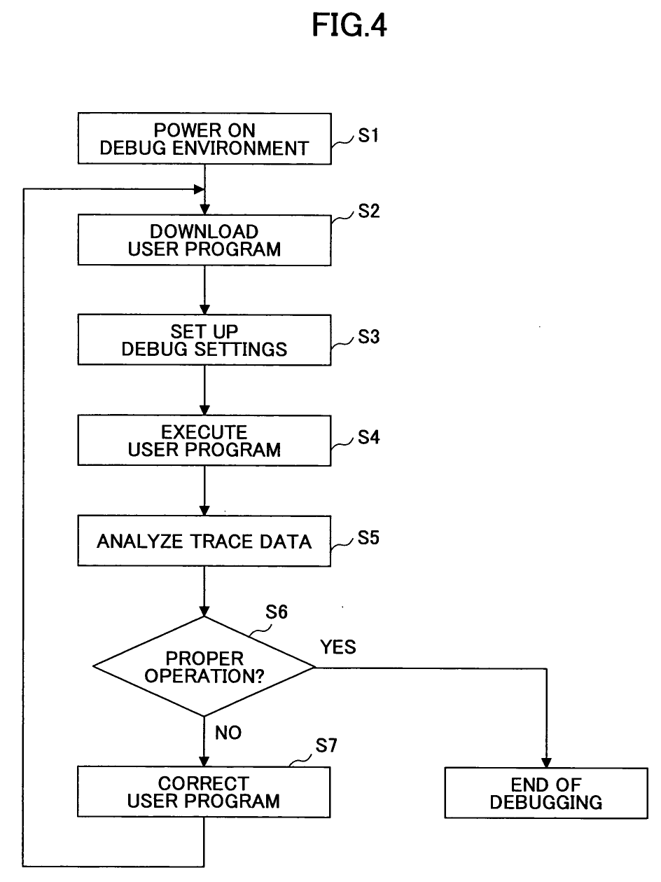

FIG. 4 is a flowchart showing the procedure performed when the debugging system of FIG. 2 debugs the microcomputer 100 provided with the DSU 300 shown in FIG. 3.

At step S1 of FIG. 4, the microcomputer 100 to be debugged and the ICE are powered on, thereby starting the debugger software on the personal computer. At step S2, a user program is transferred from the personal computer to the memory of the system to be debugged via the ICE. At step S3, the user who is debugging uses the debugger to specify debug settings such as break points and trace modes with respect to the evaluation chip (microcomputer 100). At step S4, the user program is executed under the debug settings set at step S3. At step S5, the trace data is analyzed after stopping the execution of the user program by a command break or the like. At step S6, a check is made based on the analysis of the trace data as to whether the system has operated properly. If it did not operate properly, the user program is corrected at step S7, followed by returning to step S2 for the execution of the processes of step S2 and subsequent steps. If it is determined at step S6 that the system operated properly according to the user program, the debug operation comes to an end.

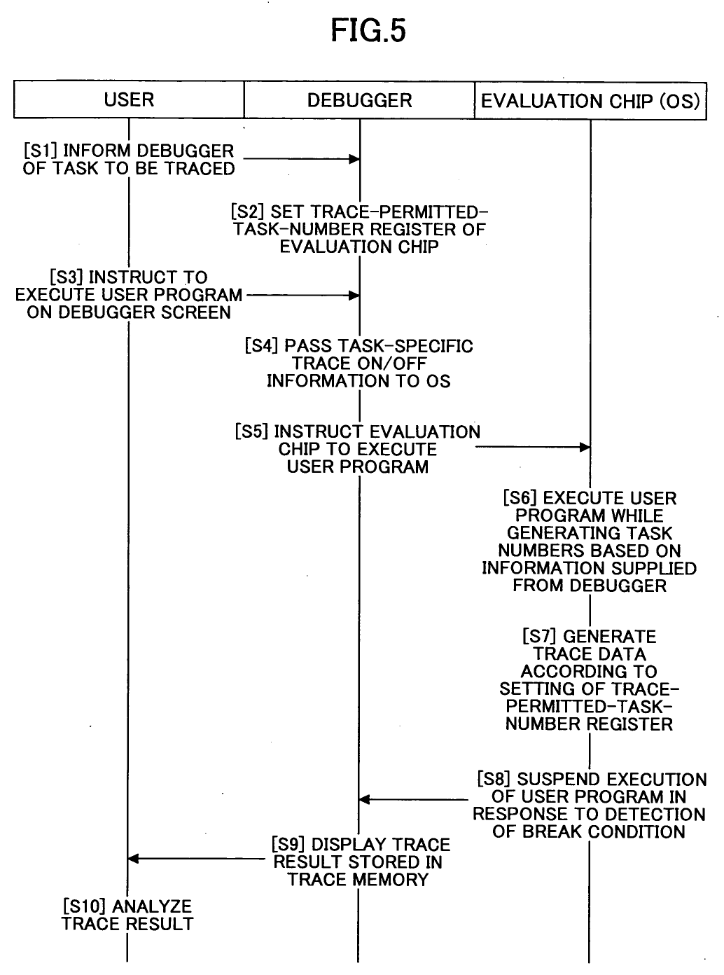

FIG. 5 is a sequence chart showing the sequence of operations performed by the user, the debugger (personal computer 17 and ICE 16), and the evaluation chip (microcomputer 100). The sequence of operations shown in FIG. 5 shows the detail of the processes performed from step S3 to step S5 in FIG. 4.

The user notifies the debugger of the task to be traced (step S1). In response, the debugger operates in the emulator mode to set the task number of the task to be traced in the register 201 (trace-permitted-task-number register) of the evaluation chip (step S2). Then, the user instructs to execute the user program on the debugger screen (step S3). In response, the debugger passes task-specific trace information (information about the task number of the task to be traced, etc.) to the OS of the evaluation chip (step S4), and instructs the evaluation chip to execute the user program (step S5). With the information about the task number of the task to be traced being passed to the OS of the evaluation chip, the OS can generate task numbers in such a manner as to satisfy the requirements when generating tasks.

In response to the instruction requesting the execution of the user program, the CPU 2 of the evaluation chip shifts from the emulator mode to the user mode to execute the user program (step S6). The execution of the user program starts first with the execution of the OS. The OS writes its own task number in the register 200 first. This is because the trace circuit 500 needs to identify the type of the program being executed by the CPU at a given time. Using the debugger, the user may instruct to include the operation of the OS as a target to be traced. In this case, the OS sets to itself the task number of the task to be traced. Then, the OS sets up the environmental necessary for the execution of a user task, followed by writing the task number of the next task to be executed in the register 200. When control returns to the OS upon task switching, the OS writes its own task number again in the register 200 immediately after the return of control. Thereafter, the OS writes task numbers in the register 200 at the beginning and end of each OS process performed at the time of task switching.

With the user program being executed as described above, the trace circuit 500 of the evaluation chip generates and stores trace data (step S7). To be specific, the comparator 202 checks whether the conditions required for the generation of trace data are satisfied, by comparing the value of the register 201 (trace-permitted-task-number register) with the value of the register 200. The output of the comparator 202 is supplied to the trace data generating circuit 203 to control the on/off of the trace operation (or control the on/off of the operation to record the trace data).

The provision is thus made to control the collecting of trace data on a task-specific basis with respect to tasks inclusive of the OS task. With this provision, the trace data of the task of interest is not buried in the trace data of unnecessary tasks. If the OS is not specified as a task to be traced, for example, most of the task switching operations performed by the OS are left out of the trace list, resulting in significantly shorter trace data.

When the execution of the user program comes to a halt in response to the detection of a break condition or the like (step S8), the CPU 2 of the evaluation chip shifts from the user mode to the emulator mode, and the debugger retrieves the trace results from the trace memory 6 for display on the screen (step S9). Based on the displayed data, the user analyzes the trace results (step S10).

In the following, embodiments of the present invention will be described with reference to the accompanying drawings.

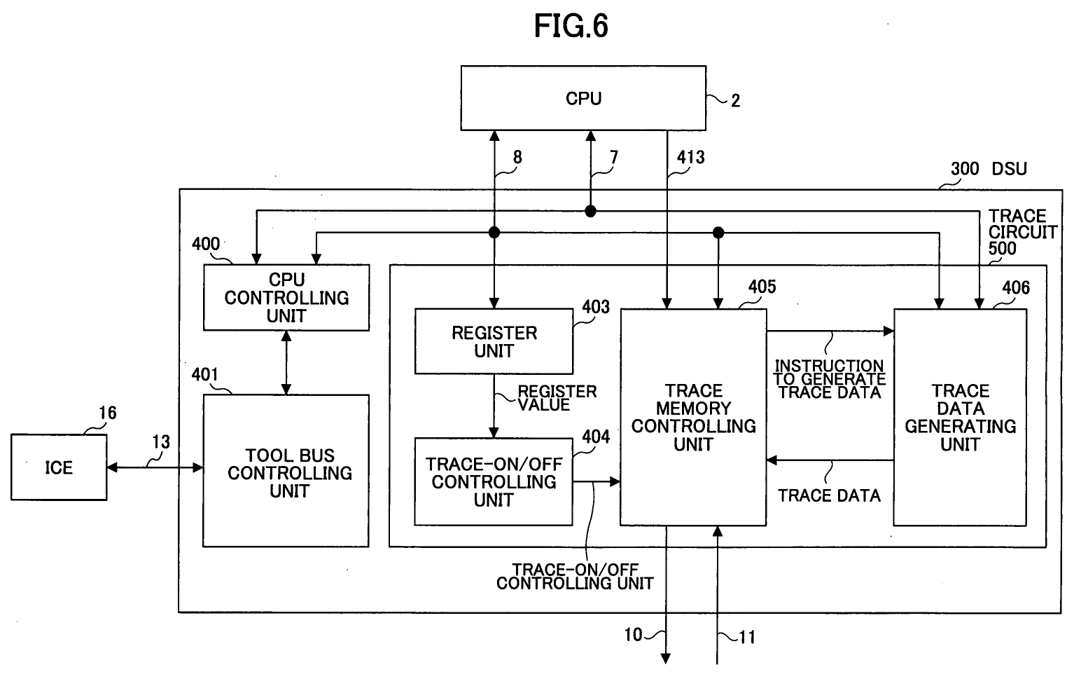

FIG. 6 is a block diagram showing an example of the embodiment of the DSU 300. The DSU 300 of FIG. 6 includes the CPU controlling unit 400, the tool bus controlling unit 401, and the trace circuit 500. The trace circuit 500 includes a register unit 403 inclusive of two or more register circuits, a trace-on/off controlling unit 404, a trace memory controlling unit 405, and a trace data generating unit 406. The signal line 413 serves to supply a mode signal that is output from the CPU 2, and indicates which one of the emulator mode and the user mode the microcomputer 100 is operating on.

In this embodiment, when the user uses the debugger to set up trace conditions, the emulator program executed by the CPU 2 writes the data in the register unit 403. This operation for setting up trace conditions is performed as follows. The CPU 2 issues a command request to the ICE 16 by using the command bus 7. At this time, the CPU controlling unit 400 in the DSU 300 is monitoring both the command bus 7 and the data bus 8 in order to arbitrate access requests simultaneously issued from these busses, and informs the tool bus controlling unit 401 of the request having higher priority. In response, the tool bus controlling unit 401 fetches a command from the ICE 16 through the tool bus 13.

The CPU controlling unit 400 issues a wait against a command access request from the CPU 2 until the command code is obtained from the ICE 16, thereby controlling the operation timing of the CPU 2. When the command code of the emulator program is supplied from the ICE 16, the CPU 2 executes this command to write the settings specified by the user in the register unit 403 via the data bus 8. At this time, the mode signal of the signal line 413 indicates the emulator mode, so that the trace memory controlling unit 405 prevents the trace data generating unit 406 from generating trace data regardless of the settings of the register unit 403.

When the setting of the registers in the emulator mode is all finished, the user instructs through the debugger to execute the user program. This is done by replacing, in the ICE 16, the emulator program currently executed by the CPU 2 provided by the ICE 16 with a command for shifting the CPU to the user mode. Upon this mode change, the mode signal of the signal line 413 indicates the user mode.

The CPU 2 then starts the execution of the user program. In the case of a system using a multitask OS, the OS is executed first as a user program. The OS initializes the system, registers tasks, and starts each of the tasks.

The multitask OS used in the present invention writes its own task number in the register unit 403 prior to the initialization of the system. When control is to be switched to the next task to be performed after the initialization and the like by the OS, the task number of the task to be performed is written in the register unit 403 before the tasks are actually switched. Control is returned to the OS from each task after the passage of a predetermined time period or in response to the issuance of a system call. At this time, the OS first writes its own task number in the register unit 403. When the process by the OS is to come to a halt, the task number of the next task is set again in the register unit 403, followed by the switching of tasks. Thereafter, the CPU alternately executes the OS and each task until the CPU 2 shifts to the emulator mode by a break function or the like provided in the ICE 16 for debugging purposes.

Reaching a break point provided for the debugging purpose or because of other reasons, the operation of the CPU 2 shifts to the emulator mode. Upon transition to the emulator mode, the mode signal of the signal line 413 indicates the emulator mode, so that the trace memory controlling unit 405 suspends the generation of trace data by the trace data generating unit 406.

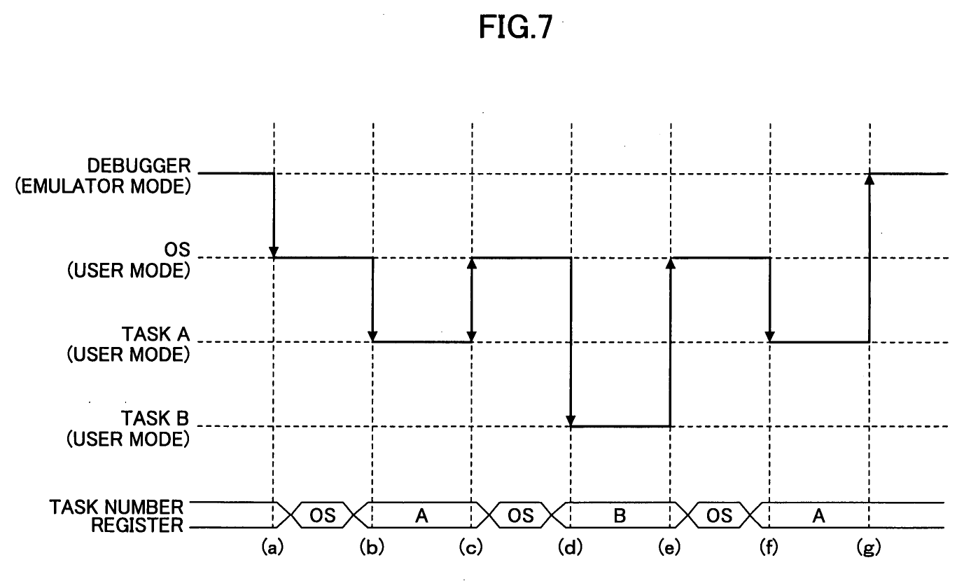

FIG. 7 is a timing chart showing the rewrite timing of the register unit 403. Here, a task number register shown in FIG. 7 is one of the registers provided in the register unit 403, and corresponds to the register 200 shown in FIG. 3.

At each timing (a), (c), and (e) shown in FIG. 7, the process by the OS starts, so that the task number of the OS is written as described above. At each timing (b) and (f), the OS writes the task number of a task A in the register unit 403 immediately before the task switch. At timing (d), the OS writes the task number of a task B in the register unit 403 immediately before the task switch. Moreover, the task A started at timing (f) is brought to a halt at timing (g) due to a break or the like from the ICE 16, resulting in control being shifted to the debugger. Because of this, the rewriting of a task number register is not performed at timing (g).

In the following, a description will be given of the on/off control of trace data generation in the configuration of FIG. 6.

The register unit 403 supplies to the trace-on/off controlling unit 404 the task number written by the OS and the task number to be traced that is stored in advance by the user request from the debugger. The trace-on/off controlling unit 404 compares the supplied numbers with each other, and sends a trace on/off control signal responsive to the comparison result to the trace memory controlling unit 405.

The trace memory controlling unit 405 instructs the trace data generating unit 406 to generate trace data if the mode signal of the signal line 413 indicates the user mode and if the trace on/off control signal indicates a trace-on. Having received this instruction, the trace data generating unit 406 generates the trace data conforming to the requested trace conditions based on the data on the command bus 7 and data bus 8. The trace data generating unit 406 supplies the generated trace data to the trace memory controlling unit 405.

The trace memory controlling unit 405 is provided with a write pointer pointing to the trace memory 6, and writes the trace data in the trace memory 6 through the data-write bus 10 if there is available space in the trace memory 6. The write pointer is automatically incremented after the write operation. If there is no space in the trace memory 6, the trace memory controlling unit 405 may stop the generation of further trace data by the trace data generating unit 406. Alternatively, the trace memory controlling unit 405 may continue the writing of trace data by using the trace memory 6 as a ring buffer if so specified according to the settings of the trace condition register 408.

When a transition to the emulator mode occurs in response to a break request from the ICE 16 or the like, the mode signal of the, signal line 413 changes and indicates the emulator mode. As a result, the trace memory controlling unit 405 instructs the trace data generating unit 406 to suspend the generation of trace data, thereby to stop storing the results of execution of the emulator program in the trace memory 6.

In the configuration of this embodiment, the emulator program executed by the CPU 2 performs a read operation with respect to the trace memory 6 allocated in the memory space, thereby reading the trace data stored in the trace memory 6 through the data-read bus 11 and the trace memory controlling unit 405. The retrieved trace data is supplied to the ICE 16 through the CPU controlling unit 400, the tool bus controlling unit 401, and the tool bus 13, and may be displayed on the screen of the personal computer 17 on which the debugger is operating.

The trace memory 6 may be implemented by use of a 2-port RAM, which allows simultaneous read and write accesses, and a dedicated bus may be provided to connect between the trace memory controlling unit 405 and the tool bus controlling unit 401. With this provision, it is possible to output the trace data to the ICE 16 automatically in parallel with the execution of the user program. In this case, it suffices to provide the trace memory controlling unit 405 with a read pointer for reading the trace memory 6 in response to a request from the tool bus controlling unit 401, with the automatic increment of the read pointer after a read operation.

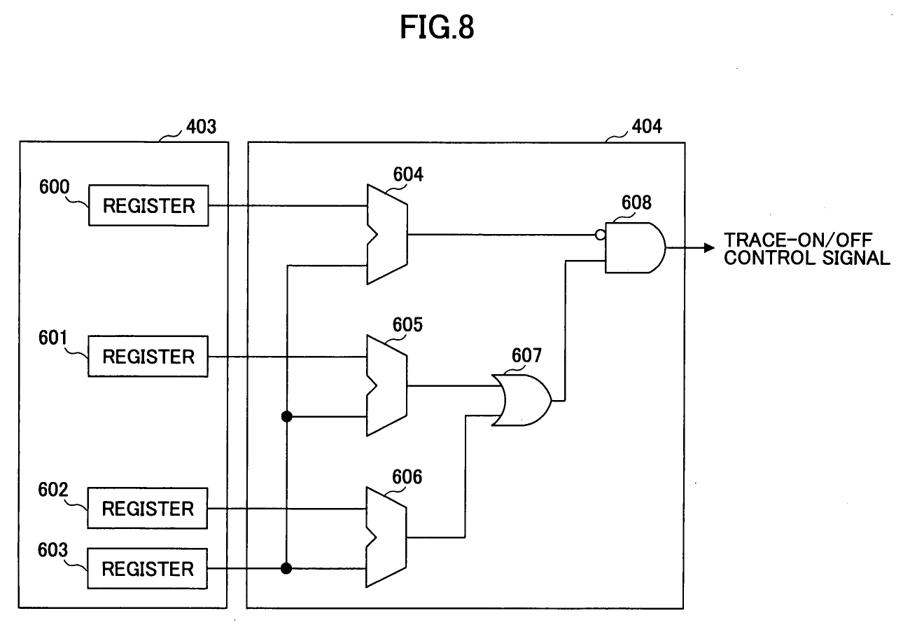

FIG. 8 is a circuit diagram showing an example of the construction of the register unit 403 and trace-on/off controlling unit 404 of FIG. 4. In FIG. 8, the register unit 403 includes registers 600 through 603, and the trace-on/off controlling unit 404 includes comparators 604 through 606, an OR circuit 607, and an AND circuit 608 with one of its two inputs being a negative logic input. In this configuration, the register 600 is a trace-prohibited-task-number register, the register 601 a trace-permitted-task-number register, and the register 602 a second trace-permitted-task-number register. The register 603 is a task number register in which a task number is written by the OS at the time of task switch.

In debugging the system comprised of tasks A, B, and C, for example, it may be desired to collect the trace data of the task C at all times whereas the trace data of the OS is not necessary. In this case, the task number of the OS is set in the register 600, the task number of the task C set in the register 601, and the task number of the task A, selected as an example among the task A and the task B, set in the register 602. When the OS is executed for the execution of the user program, the task number of the OS is set in the register 603, resulting in the output of the comparator 604 being asserted. The trace-on/off control signal output from the trace-on/off controlling unit 404 thus indicates a trace-off.

When the task A or C is executed for the execution of the user program, the task number of the task A or C is set in the register 603, resulting in the output of the comparator 606 or the comparator 605 being asserted. The trace-on/off control signal thus indicates a trace-on. The register 601 may be set to the task (the task C in this example) for which trace data needs to be collected at all times. With this provision, the rewriting of the content of the register 602 suffices to change the task of interest (e.g., from the task A to the task B) along with the progress of debugging operation.

In the embodiment described above, the generation of trace data is prohibited while the mode signal of the signal line 413 (FIG. 6) indicates the emulator mode, but the generation of trace data cannot be prohibited after a transition to the user mode until the OS sets the task number register. In the timing chart of FIG. 7, for example, the generation of trace data is prohibited in the emulator mode until timing (a). Thereafter, however, the mode signal indicates the user mode, and the content of the task number register 603 is not yet set until the OS writes its own task number in the task number register 603. During this period, thus, the generation of trace data cannot be controlled.

It is thus desirable to use the debugger to initialize the task number register to a proper setting value when the debugger initializes the DSU 300 prior to debugging operation. If the OS is included in the tasks to be traced, for example, a transition to the user mode may be made after the debugger sets the task number register 603 to the same value as the trace-permitted-task-number register 601. This provision makes it possible to collect trace data immediately after the transition to the user mode is made. If the OS is not included in the tasks to be traced, a transition to the user mode may be made after the debugger sets the task number register 603 to the same value as the trace-prohibited-task-number register 600. This provision makes it possible to prohibit the collecting of trace data immediately after the transition to the user mode is made.

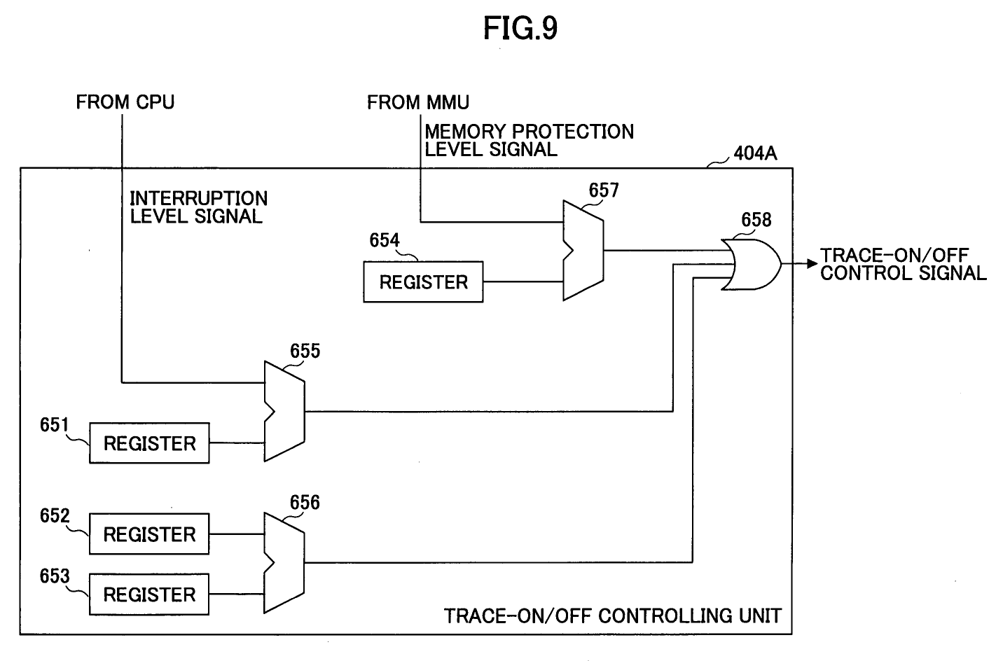

FIG. 9 is a circuit diagram showing another example of the construction of the register unit and the trace-on/off controlling unit. In FIG. 9, the register unit and the trace-on/off controlling unit are combined together as a trace-on/off controlling unit 404A. The trace-on/off controlling unit 404A includes registers 651 through 654, comparators 655 through 657, and an OR circuit 658.

The construction of FIG. 9 is designed for a case in which the CPU supports multilevel interruptions or the MMU (memory management unit) supports a memory protection level. In such a case, the trace-on/off control signal can be generated by using an interruption level signal or a memory protection level signal. In FIG. 9, the registers 652 and 653 are, respectively, a trace-permitted-task-number register and a task number register in which the OS writes a task number at the time of task switch, as in the previous embodiment. The register 651 stores an interruption level supplied in advance from the debugger in the emulator mode. The comparator 655 compares a current interruption level signal supplied from the CPU with the value of the register 651 so as to generate a trace-on/off control signal. The register 654 stores a memory protection level supplied in advance from the debugger in the emulator mode. The comparator 657 compares a current memory protection level signal supplied from the MMU with the value of the register 654 so as to generate the trace-on/off control signal.

With this provision, it is possible to record trace data with respect to the execution of a specified interruption handler or the execution of a task having a specified memory protection level, for example.

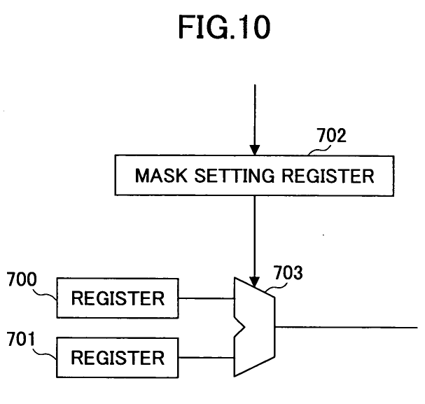

FIG. 10 is a circuit diagram showing the construction in which task number comparison is provided with a masking function. A comparator 703 of FIG. 10 is a comparator such as the comparators 604 through 606 of FIG. 8 that compares task numbers with each other. The comparator 703 compares a task number stored in a register 700 with a task number stored in a register 701. The register 700 and the register 701 are a trace-permitted-task-number register and a task number register in which the OS writes a task number at the time of task switch, respectively.

A mask setting register 702 stores masking data. The masking data specifies the bits that are subject to comparison by the comparator 703. For the sake of simplify of explanation, it is assumed that a task number is comprised of 4 bits. Masking data “0011”, for example, is stored in the mask setting register 702. With this setting, bits at the bit positions corresponding to “1” of the masking data, i.e., the two lower-order bits in this example, are not subject to comparison by the comparator 703.

A trace-permitted task number “0100” may be set in the register 700, for example. When the OS writes a task number “0101” in the task number register 701, the two lower-order bits of “0100” and “0101” are masked, and only the two upper-order bits are compared. As a result, these two task numbers are regarded as matching numbers.

With the use of this function, an agreement may be made in advance between the debugger and the OS that the two upper-order bits are “00” for an OS task, “01” for a task to be traced at all times, and “10” for a task to be not traced. The remaining lower-order bits (e.g., 14 bits) can then be freely assigned to tasks by the OS.

Further, the present invention is not limited to these embodiments, but various variations and modifications may be made without departing from the scope of the present invention.

For example, the registers other than the task number register in these embodiments may be implemented as circuits indicative of fixed task numbers by use of wired logic in accordance with the rules of task number assignment that are agreed upon between the debugger and the OS. This reduces the circuit size.

What is claimed is:

1. A microcomputer, comprising:
a bus;
a CPU coupled to said bus;
a trace data generating circuit coupled to said bus to output trace data of a process executed by said CPU at an output node;
a memory coupled to the output node of said trace data generating circuit to store the trace data;
a first register coupled to said bus to store a task number indicative of a task being executed by said CPU; and
a control unit coupled to said first register to control on/off of outputting of the trace data from said trace data generating circuit in response to said task number.

2. The microcomputer as claimed in claim 1, further comprising at least one second register configured to store a predetermined task number, wherein said control unit permits the outputting of the trace data from said trace data generating circuit in response to at least partial agreement between a stored value of said first register and a stored value of said second register.

3. The microcomputer as claimed in claim 2, further comprising a third register configured to store a predetermined task number, wherein said control unit prohibits the outputting of the trace data from said trace data generating circuit regardless of the stored value of said at least one second register in response to at least partial agreement between the stored value of said first register and the stored value of said third register.

4. The microcomputer as claimed in claim 2, wherein said control unit is provided with a function to perform bit masking when checking whether at least partial agreement exists between the stored value of said first register and the stored value of said second register.

5. The microcomputer as claimed in claim 1, wherein said control circuit is further configured to control the on/off of the outputting of the trace data from said trace data generating circuit in response to a signal indicative of a level of the task being executed by said CPU.

6. A method of controlling tracing in a microcomputer, comprising the steps of:
a) letting a CPU execute a user program;
b) letting the CPU store in a first register a task number of a currently executed task during the execution of the user program; and
c) controlling on/off of recording of trace data with respect to a process executed by the CPU in response to the task number stored in the first register.

7. The method as claimed in claim 6, further comprising a step of letting a debugger store a desired task number in a second register, wherein said step c) permits the recording of the trace data in response to at least a partial agreement between a stored value of the first register and a stored value of the second register.

8. The method as claimed in claim 7, further comprising a step of letting a debugger store a desired task number in a third register, wherein said step c) prohibits the recording of the trace data regardless of the stored value of the second register in response to at least partial agreement between the stored value of the first register and the stored value of the third register.

9. The method as claimed in claim 7, wherein said step c) performs bit masking when checking whether at least partial agreement exists between the stored value of the first register and the stored value of the second register.

10. The method as claimed in claim 6, further comprising a step of controlling the on/off of the recording of the trace data in response to a signal indicative of a level of the task being executed by the CPU.
